(19) United States
(12) Patent Application Publication
(10) Pub. No.: US 2007/0237201 A1
(43) Pub. Date: Oct. 11, 2007

(54) Method and Apparatus for Analyzing Thermo-Graphic Images to Detect Defects in Thermally Sealed Packaging

(75) Inventor: Steven Ignatowicz, Grayslake, IL (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: IRCON, INC., Niles, IL (US)

(21) Appl. No.: 11/697,167

(22) Filed: Apr. 5, 2007

Related U.S. Application Data
(60) Provisional application No. 60/789,974, filed on Apr. 6, 2006.

(51) Int. Cl. G01N 25/00

(52) U.S. Cl. 374/7

(57) ABSTRACT

A method of monitoring and detecting thermal sealing defects includes capturing a thermal image of a thermal seal, obtaining a reference thermal image corresponding to an acceptable thermal seal, converting the captured thermal image to a first sequenced set of pixel values, converting the reference thermal image to a second sequenced set of pixel values, defining a plurality of regions such that each region includes a plurality of sequence numbers such that each sequence number is a sequence number of a pixel value in the first sequenced set, generating a sequenced set of differential values such that each differential value is associated with the first ordered set of pixel values and with the second ordered set of pixel values, and analyzing the sequenced set of differential values.

### CROSS-REFERENCE TO RELATED APPLICATIONS

This application claims benefit of the following United States Provisional Applications: Ser. No. 60/789,974, entitled “An Improved Method and Apparatus for Analyzing Thermographic Images to Detect Defects in Thermally Sealed Packaging” filed Apr. 6, 2006 (attorney docket no. 29123/40154B), the disclosure of which is hereby expressly incorporated herein by reference.

### FIELD OF THE DISCLOSURE

The present disclosure is generally directed to method and apparatus for detecting defects in plastic sealing and, more particularly, a method and apparatus for detecting defects in plastic sealing using an infrared imaging system.

### BACKGROUND OF THE DISCLOSURE

Thousands of different products are packaged in some kind of plastic container. The food industry uses them for such items as frozen pizza, frozen vegetables and fountain soda. One example is ajar of nuts where a metalized paper cover is secured to the jar by induction heating of the lid. The medical industry uses plastic bags for IV solutions and blood among others. For example, containers are the sealed by pressing a top and bottom of the container together with heater bars. In some cases a failed seal may affect the shelf life of the product or allow contaminants to enter. In another case, such as holding laundry detergent tablets, a failed seal is just a nuisance for the user. In any case, a failed seal ultimately reflects on the quality image of the supplier which may lead to a decline in future sales.

For some applications product is being sealed inside, while for others the product is the specialty plastic bag. Whether sealing in the final product or just making seals to create a bag, the process is similar. The product is indexed along the process line where it enters a heating press. The press is clamped on the areas to be sealed and then heat is applied until the plastic components are fused together. Heat is removed to start the cooling cycle before the press is released. The cycle repeats with the next part being indexed into position. Manufacturers run the cycle as quickly as possible to maximize production yield, but unfortunately the seal defects increase as the cycle speed is increased.

A thermal imaging system may function both as a tool to increase the cycle speed and also as an automatic fault detection system. Such systems may be optimized by programming the system to look past the surface of the object they are measuring, and concentrating on the actual seal that is buried beneath the surface. In doing so, a sublet defect will be more readily detected.

### BRIEF DESCRIPTION OF THE DRAWINGS

Objects, features, and advantages of the present device will become apparent upon reading the following description in conjunction with the drawing figures, in which:

FIG. 1 is an isometric view of one example of an infrared imaging system used in detecting defects in plastic seals constructed according to one embodiment of the disclosure;

FIG. 2 is a block diagram of the infrared imaging system of FIG. 1.

FIG. 3 is an example of a partial thermal image of a plurality of seals as obtained from the infrared imaging system of FIG. 1;

FIG. 4 is an example plot of image intensity levels of a reference image;

FIG. 5 is an example plot of image intensity levels of an test image;

FIG. 6 is a plot of the difference in intensity levels between the reference image of FIG. 4 and the test image of FIG. 5, utilizing a typical image matching scheme;

FIG. 7 is a plot of the difference in intensity levels between the reference image of FIG. 4 and the test image of FIG. 5, according to the image matching scheme disclosed herein;

FIG. 8 is a flowchart of one exemplary operation of monitoring and detecting a defect in a thermal seal using the infrared imaging system of FIG. 1; and

FIG. 9 is a flow diagram illustrating the image matching scheme utilized in obtaining the plot of FIG. 7.

While the method and device described herein are susceptible to various modifications and alternative constructions, certain illustrative embodiments thereof have been shown in the drawings and will be described below in detail. It should be understood, however, that there is no intention to limit the invention to the specific forms disclosed, but on the contrary, the intention is to cover all modifications, alternative constructions, and equivalents falling within the spirit and scope of the disclosure.

### DETAILED DESCRIPTION OF THE DISCLOSURE

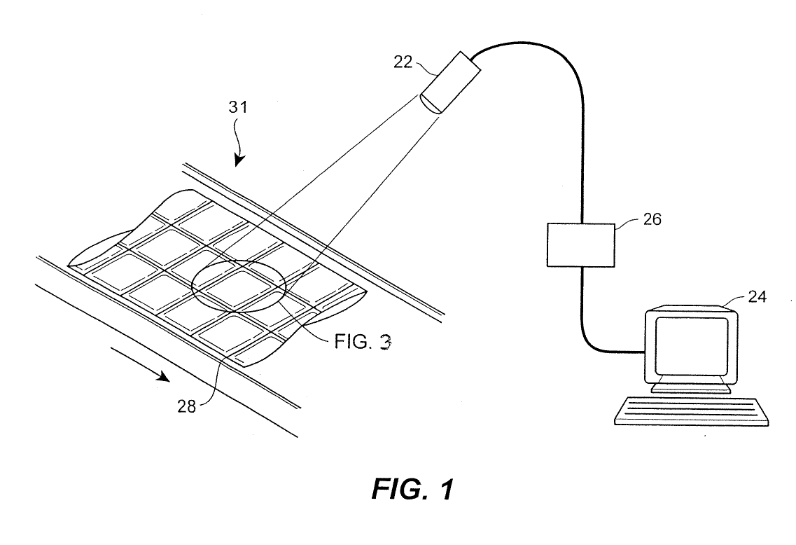

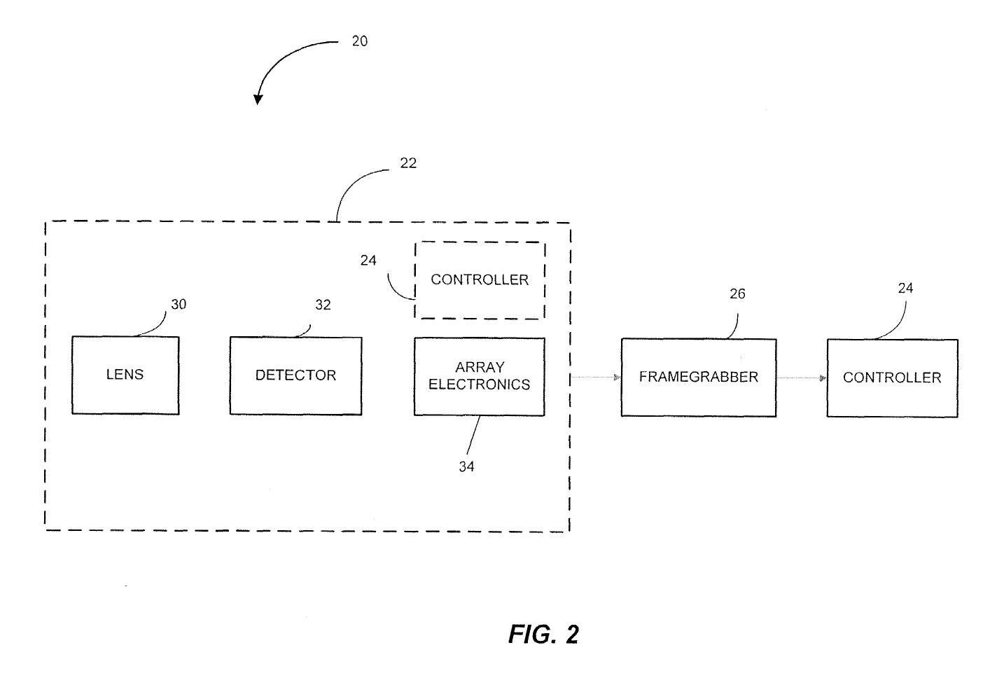

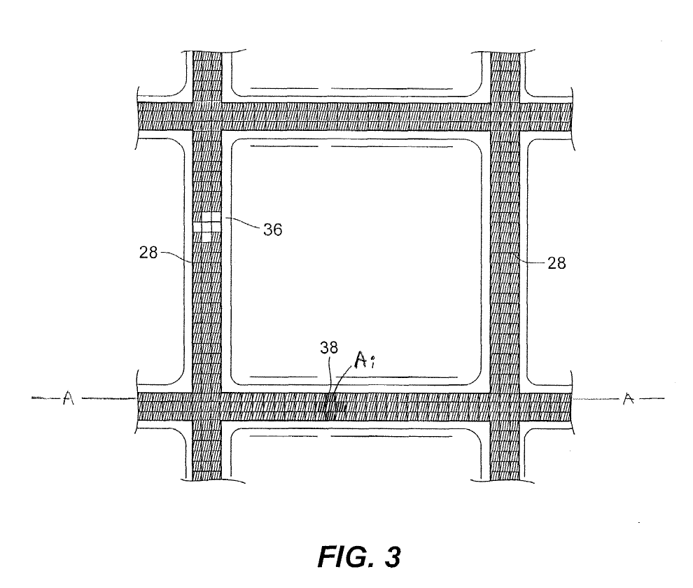

Referring now to the drawings and with specific reference to FIG. 1, an infrared imaging system constructed in accordance with the teachings of the disclosure is generally depicted by reference numeral 20. As shown therein, the imaging system 20 includes an infrared based thermal imaging camera 22 that is communicably coupled to a computing means 24 such as a common PC or controller that includes application software to implement the imaging system. The controller 24 may be disposed outside the camera 22, as seen in FIGS. 1 and 2, or may be disposed inside the camera (FIG. 2 shown in dashed lines). An interface 26 to couple the PC with the camera 22, such as a digital frame grabber 26, may be disposed between the controller 24 and the camera 22. As generally illustrated in FIG. 1 and in detail in FIG. 2, the thermal imager 22 captures a thermal image of one or more recently created seals 28. The thermal image is then processed and evaluated by the pre-programmed controller 24 to determine whether the seal 28 is of acceptable quality. As illustrated in FIGS. 1 and 3, the imaging system 20 may be used to detect seal defects on a seal 28 created by adhering two or more sheets of plastic together that may be transported on a conveyor or other transport mechanism. However, as those of ordinary skill in the art would recognize, the imaging system 20 may be used to detect seal defects on a variety of seals, such as on form fills, containers, etc. whether moving or not.

A variety of suppliers make thermal imagers that might be suitable for this application. One common type of infrared camera is based on microbolometer technology and has a typical spectral response range of 7 to 14 microns. Most of the packaging materials use thin plastics that have varying degrees of transmission in this region. The greater the transmission the more of the background the camera sees rather than the packaging material. Plastic has various regions which are substantially more opaque than others. There are many plastic formulations that will shift where the most opaque region is. To maximize the camera's sensitivity to the defects in the seals 28, the camera's spectral response should be tailored to the target material. There is a tradeoff in camera performance when the spectral range is reduced so it is best to make the spectral range as wide as possible. A good compromise for the microbolometer camera is a region of 7.5 to 8.2 microns. However, with other types of cameras a region centered near 3.4 microns may work as well.

As illustrated in FIG. 2, the camera 22 includes a lens 30 operatively connected to a detector or detector array 32. The camera 22 may also include a spectral filter to closely match the emission characteristics of the seal 28 or target material. The lens 30 optically compresses and guides the thermal image of the seal 28 onto the detector or detector array 32. The typical array 32 has a video format of 320×240 pixels yielding 76800 measurement points or pixels, but other array designs could use other formats, including but not limited to, 640×480 and 160×120. The array 30 is operatively connected to a plurality of array electronics 34 that convert the information in each piece of the array 32 to an electronic signal.

In one exemplary embodiment, the detector output is digitized with the results filling a block of memory in the controller 24 through the digital frame grabber 26. The frame grabber 26 may be used to digitize and/or store video information into a bitmap image, for example. Frame grabbers can be stand-alone units or may be a function built into video graphics boards in the camera 22.

The application software that is pre-programmed and stored in the controller 24 may have one or more components. One component of the application software is the part detection routine. An external signal could be used to signal each piece as it comes into view, but the software's auto detection logic may simplify the customer interface requirements. For example, as the part or target containing the seal 28 is moving in the field of view of the camera 22 there will be some pixels showing an increase in signal, due to the thermal activity on the target. In contrast, it is also true that some pixels will show a decrease in signal, due to the natural thermal decay that is occurring on the target. Such thermal decay is also present when the target is stationary. Therefore, sensing a decrease in signal may be an unreliable way of detecting motion.

Three variables, among others, may affect the reliability of this technique. One variable is inherent noise in the thermal imaging camera 22 which may be accounted for or covered by a temperature threshold delta adjustment. Another variable is slow moving targets which might not show enough signal change between frames. This variable may be accounted for by a setting that requires a minimum number of frames before the signal changes above the noise threshold. Finally, a false start or false trigger may be prevented or accounted for by an absolute minimum threshold temperature adjustment.

Another component of the application software is an image filtering routine. The image noise filtering relies on the concept that a hot object will cool at an exponential decay rate until it reaches thermal equilibrium with its surroundings. The routine collects data on every pixel, typically 76800 points, from every frame while the target is stationary. A best fit curve is computed for each individual pixel position using standard curve fitting techniques such as Gaussian reduction. Using such equations a clean thermal image is created along with a rate of change. It is even possible to extrapolate an image pattern for any point in time using the equations. The rate of change is important for detecting certain types of sealing faults. It is important to note that while an exponential equation is best for extrapolating images beyond the observation period a simple linear equation is usually sufficient for the fault detection logic.

Another component of the application software is commonly referred to in the vision industry as blob analysis. The blob result comes from a common function in vision systems that convert the image so that it contains only black pixels and white pixels, and thereby removes any shades of gray from the image. This is accomplished by comparing each raw pixel value against some threshold. If the value is greater than the threshold then the corresponding blob pixel is made white, otherwise it is set to black. The resulting blob pattern is sometimes easier to work with in locating parts and in doing dimensional analysis on the part.

In other words, a binary pattern is generated from the thermal image obtained from the thermal imager 22. If a pixel is above some threshold it is set to 1 otherwise it is set to 0. The blob pattern is defined by the pixels which the seal defect analysis operates on. In a number of situations it is possible to generate a complete thermal outline of the seal area, including the defective areas, because all these areas are heated. Accordingly, no reference image or data is required because the seal analysis can be completed by comparing or analyzing various portions of the seal area and the seal 28 relative to each other.

In other situations it will be necessary to rely on the blob data from a known, good reference image. In a real process the image location will shift somewhat from one part to the next. The benefit of not using a reference is that there is no need for software realignment of the test image against the reference image. The drawback to not using a reference image is that there are less failure detection criteria to choose from. Of course the user may choose to use both reference and non-reference based schemes together to either reduce false defect signals or missed faults.

Another component of the application software provides refinement of the blob pattern to make the blob pattern useful in thermal fault detection schemes. In particular, data near edges of the seal 28 may indicate temperatures substantially lower than they should. This is mainly due to the actual seal boundary not aligning with the camera's pixel boundary, but may also be due to thermal leakage into adjacent cooler areas and other factors. Accordingly, the software may use a blob thinning or blob fattening routine to affect boundaries of the seal 28.

One thinning scheme is based on looking at eight surrounding pixels of any particular pixel. If the surrounding pixels are all ones then a one is written a 1 to the new blob, otherwise is written a 0. Other trimming or thinning schemes may prove useful under certain circumstances. For example, if the seal 28 is just a horizontal bar you may only want to look at the pixels above and below the seal 28.

One fattening scheme, for aligning the blob pattern with a reference blob, for example, includes looking at the eight surrounding pixels of a pixel and writing a one if any of the surrounding pixels is a one, or writing a 0 if they all are zero. The image is then incrementally shifted up, down, left, and right a reasonable number of pixels and correlated against the reference image. The adjusted alignment is then assumed to be the position that yields the highest correlation.

Another blob refinement scheme is to allow the user to manually edit the reference blob adding or subtracting to the image, but many other blobbing schemes, additional to the ones disclosed herein, may be used.

Another component of the application software provides the detection of faults or failures in the seal 28. The faults may be detected by using a reference or a non-reference detection scheme.

There are two schemes for detecting faults without comparing to a reference. The two schemes each look at the value of the thermal data only at the locations where the blob pattern has a 1. The first scheme looks at the absolute temperature and if any pixel is below some adjustable threshold a fault is indicated. The second scheme looks at the rate of change of the pixels and, again, if any pixel is below some adjustable threshold a fault is indicated. The rate of change scheme best detects faults originating from extra material occurring in the seal area. The extra material may be from a fold in the plastic or other contaminants. The material still reaches the same absolute temperature in the press but the larger mass slows the cooling rate and, hence, is detected.

More specifically, as the seal 28 comes to a rest, at least a first thermal image and a second thermal image will be obtained. More likely, however, a plurality of thermal images will be obtained including the first thermal image and a last thermal image. Accordingly, by subtracting the intensity of the last thermal image from the first thermal image, a difference in intensity is obtained. The elapsed time between the first and last thermal image is also known. Thus, by dividing the elapsed time between the taking of the first and last thermal image into the difference in intensity of the first and last thermal image, a thermal rate of change or a rate of change of intensity is obtained. As briefly described above, this a rate of change may be utilized to obtain a blob image, but may also be utilized in fault detection schemes, or any other scheme that may benefit from comparing rates of change.

There are several fault detection schemes that may be implemented when comparing against a reference. One technique is calculating the correlation between the test image and the reference image. The sensitivity of this technique is improved by using only thermal data corresponding to the fat blob results. Other techniques may include the standard deviation or the maximum deviation between the images, but many other fault detection schemes, additional to the ones disclosed herein, may be used.

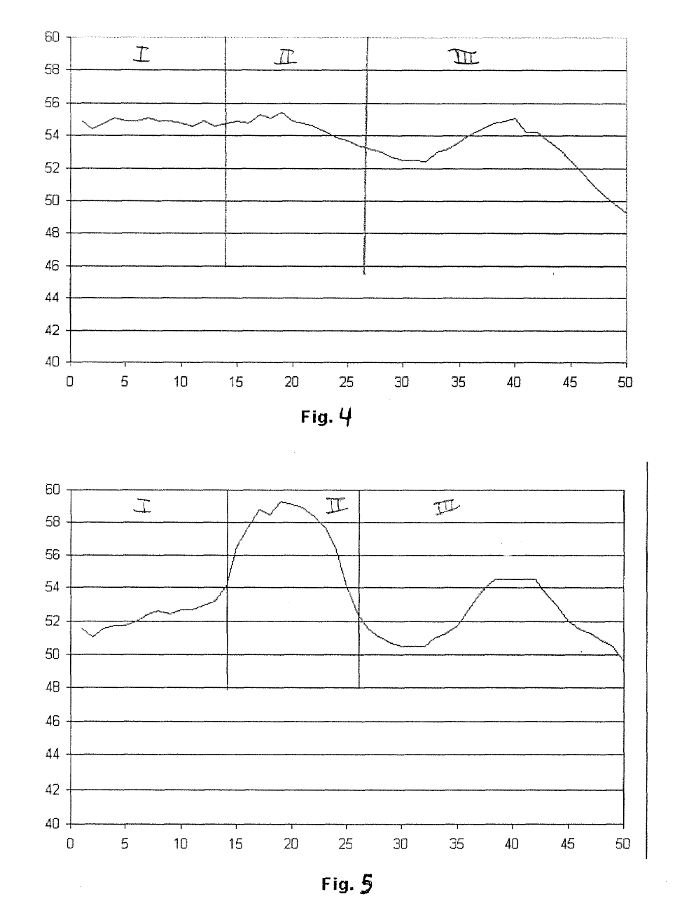

In one exemplary fault detection scheme, as is shown in FIGS. 4-7 and 9, the test image is not compared to the reference image on a pixel by pixel or point per point bases, but is rather compared by obtain a difference of the values surrounding the point to pixel at issue.

Specifically, as mentioned above, many vision pattern matching routines rely on comparison of the test image against an idealized reference image. One way of obtaining an idealized reference image is to average the data from several good parts. However, the reference image may be obtained in any manner know to those of ordinary skill in the art. In addition, while the typical thermal image is composed of a two dimensional array of intensity values, for clarity just a subset of data from a single column will be used to illustrate the concept. Of course, the method applies equally well to rows of data. For a complete implementation, the method would be applied across all rows in one inspection and across every column in a second inspection.

Referring now to FIG. 3, row “A” depicts a plurality of pixels or points, including pixel Aᵢ, wherein the pixel Aᵢ is part of the seal defect 38. The intensity of pixels in that row may be displayed in an intensity plot as shown in FIGS. 4-7. In particular, FIG. 4 is an intensity plot of a reference image depicting a portion of the reference image corresponding to row A. The reference image is assumed to be an image of an acceptable seal, and includes regions I, II and III. In contrast, FIG. 5 shows a corresponding intensity plot of a test sample, wherein region II is now a faulty region—Aᵢ being part of that faulty region. Regions I and III are regions with no defects.

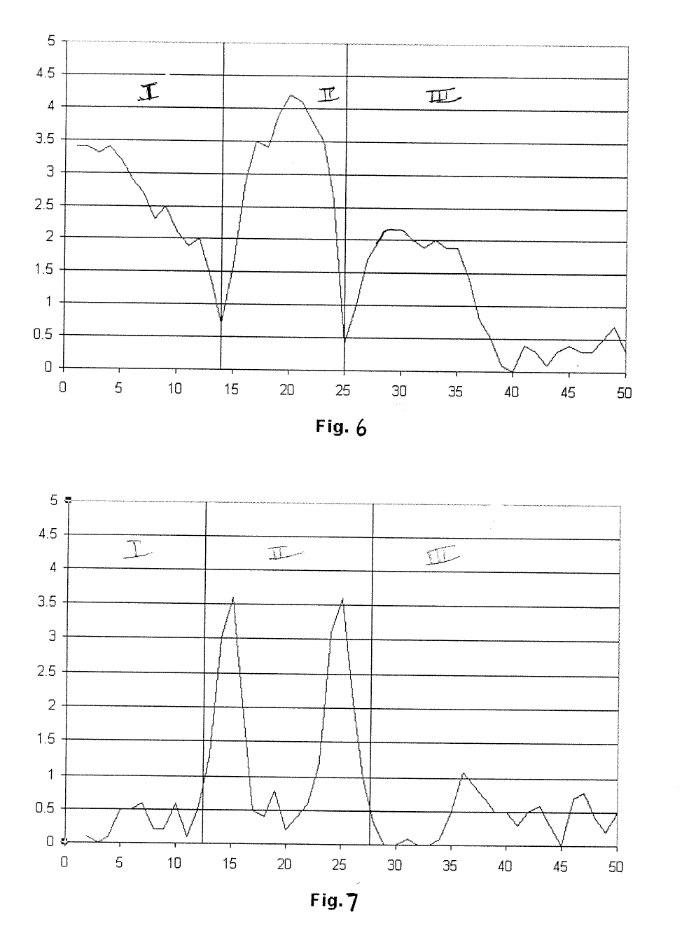

One typical pattern matching scheme is to subtract the intensity values from the two images and look at the resultant absolute deviation, as sown in FIG. 6. If the largest deviation is greater than some threshold then a fault is indicated. The resultant deviation plot shows little margin between the maximum deviation in the good region I compared with the faulty region II.

To provide a numerical value in evaluating the sensitivity of the comparison methods, a sensitivity value can be defined where the larger the value the better the reliability for fault detection.

In particular, sensitivity value=PeakBadValue/PeakGoodValue

For the resultant data as shown in FIG. 6, the sensitivity value is 4.2/3.4=1.2

Using the following disclosed technique a sensitivity value greater than 3 is achieved from the data.

In brief the junction where a good seal section meets a bad seal section is detected by a differential change in intensity level surrounding the boundary point.

Assume:

i represents a column position

n represents the last position in the column

R[i] represents a value in the Reference column

S[i] represents a value in the Sample column

DV[i] represents a value in the Differential Value column

Abs( ) is the absolute value function

A differential value is computed for each intensity value using the formula:

DV[i]=Abs((S[i−1]−S[i+1])−(R[i−1]−R[i+1]))

When applied to the test data of FIGS. 4 and 5, the plot of FIG. 7 is revealed. FIG. 7 shows the bad region II and good regions areas I and III. Using data from the plot the sensitivity value is computed as 3.6/1.1=3.2

A simple implementation has been described which can be expanded upon. Measurement noise can be reduced for example by averaging two or more previous values and then subtracting the average of two or more following samples to get a filtered differential value.

The results of each of the detection schemes may be combined logically in various ways to produce a single pass fail indication. The system may provide one or more methods of notifying the user of the pass/fail result. Two common outputs may be a relay contact and TCP/IP based communications. The results of the detection schemes may also be utilized in many other ways, with various types of output devices. For example, an output of the controller 24 may be communicably coupled to a monitor or display for viewing the seal 28.

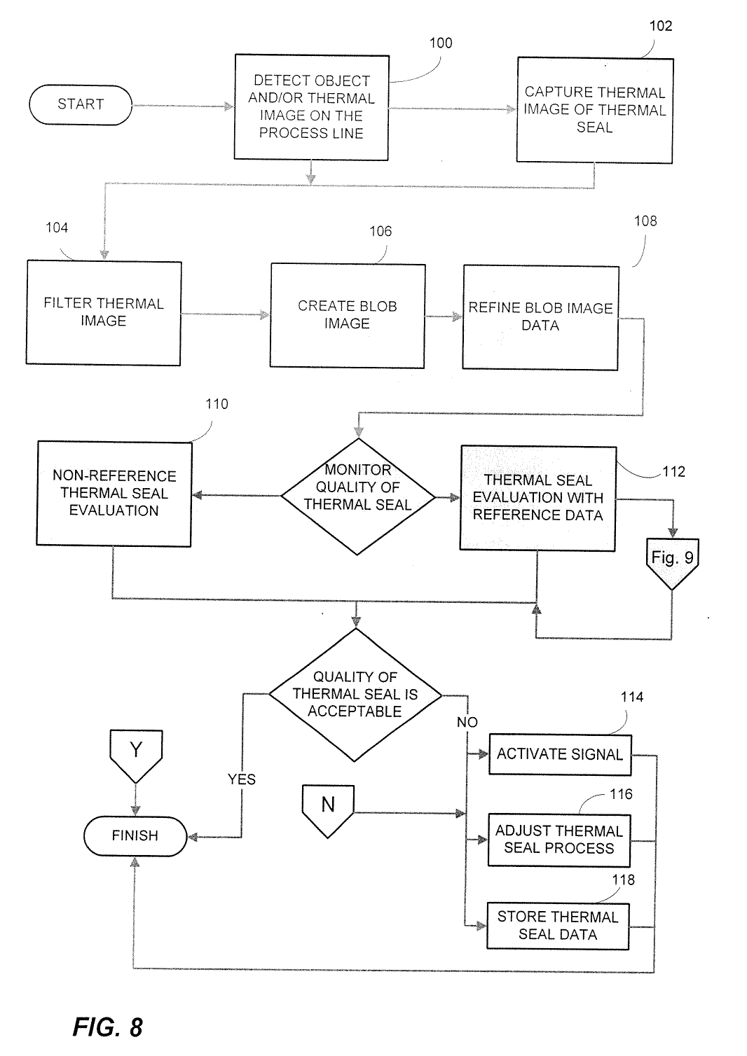

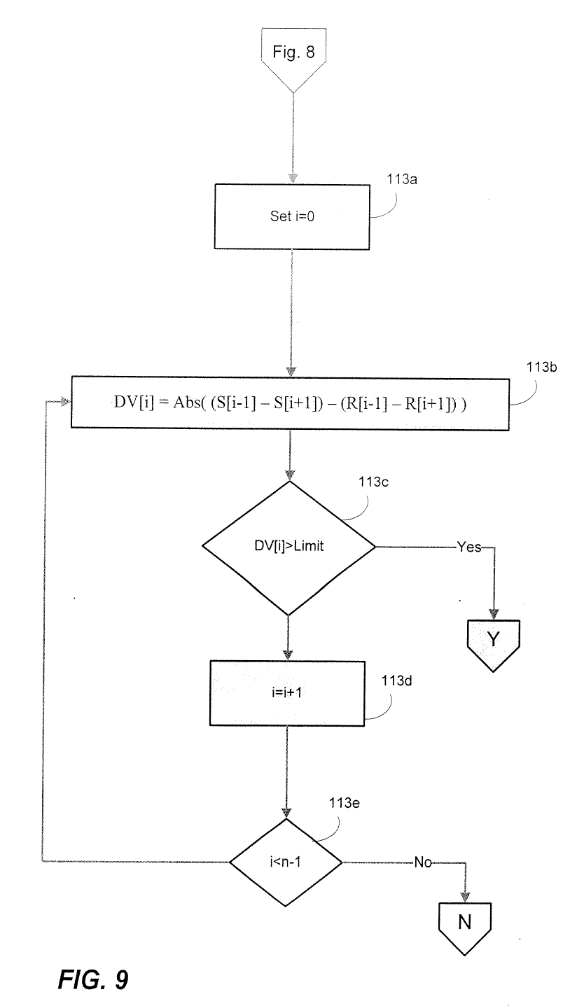

In an exemplary operation, as is shown in FIG. 8, the imaging system 20 may be used to detect a fault in the seal 28, and may be used to measure the quality of the seal 28. The seal 28 may come in many shapes and forms, and may be used in a great variety of applications and environments, but for clarity and brevity the seal 28 used herein is a simple seal constructed by the joining of two plastic layers, as is illustrated in FIG. 3.

The two layers of plastic, one disposed on top of the other, may be disposed on a conveyer system 31 (FIG. 1), or the like, during the seal creation and seal inspection process. As the seal 28 comes into the view of the thermal imaging camera 22, the imaging system 20 may obtain one or more thermal images of the seal 28. The thermal image may be used for indexing or locating the seal 28 (block 100), but may be used for later analysis. Alternatively, a separate thermal image for analysis of the seal 28 may be obtained at block 102. Once the thermal image has been obtained, the imaging system 20 may begin a filtering routine to enhance the image quality (block 104). At block 106 the thermal image may be converted into a blob image or pattern, which may then be refined at block 108. Using a reference or non-reference methodology, at blocks 112 and 110, respectively, the imaging system 20 may inspect the seal 28 to determine if a fault or other undesirable quality is present in the seal 28, or if the seal 28 meets approval. For example, as seen in FIG. 3, the image resulting from the seal 28 may show a cool spot or zone 36 indicating that the seal 28 may be too thin or that a hole has been created in the seal 28 during the sealing process. In contrast, the image resulting from the seal 28 may show a hot spot or zone 38 indicating that the seal 28 may be too thick or that an extra layer of plastic or debris has been made part of the seal 28.

For example, as illustrated in FIG. 9, at block 113a the pixel count or “i” is set to zero to represent the beginning of a row or column of pixels to be evaluated. Using the equation in block 113b, an absolute difference in intensity value between the reference image and the test image is obtained. If the absolute difference is above a threshold or limit, the quality of thermal seal is unacceptable. In contrast, if the absolute difference is within the threshold or limit, the iteration may be continued at block 113d and diamond 113e, until it is determined that the end of the column or row has been reached. If the end has not been reached the iteration will continue to block 113b. The information resulting from the inspection of the seal 28 may then be utilized in several manners. For example, if the quality of the seal 28 is unacceptable, the information may be stored on the PC or controller 24 or other electronic device communicably coupled to the imaging system 20 at block 118, the information may be used to active a signal or alarm, such as “good” or “bad” at block 114, and/or may be used to adjust or alter the manufacturing process at block 116. If the quality of the seal 28 is acceptable, however, the inspection of other seals may continue.

Although certain embodiments of an imaging system 20 have been described herein in accordance with the teachings of the present disclosure, the scope of coverage of this patent is not limited thereto. On the contrary, this patent covers all embodiments of the teachings of the disclosure that fairly fall within the scope of permissible equivalents.

What is claimed:

1. A method of monitoring and detecting thermal sealing defects, comprising:
capturing a thermal image of a thermal seal;
obtaining a reference thermal image corresponding to an acceptable thermal seal;
converting the captured thermal image to a first sequenced set of pixel values;
converting the reference thermal image to a second sequenced set of pixel values;
defining a plurality of regions, wherein each region comprises a plurality of sequence numbers such that each sequence number is a sequence number of a pixel value in the first sequenced set;
generating a sequenced set of differential values, wherein each differential value is associated with the first ordered set of pixel values and with the second ordered set of pixel values; and
analyzing the sequenced set of differential values.

2. The method of claim 1, wherein generating each differential value in the sequenced set includes performing a calculation involving:
a first pixel value from the first set, wherein the sequence number of the first pixel value is one less than the sequence number of the differential value;
a second pixel value from the first set, wherein the sequence number of the second pixel value is one more than the sequence number of the differential value;
a third pixel value from the second set, wherein the sequence number of the third pixel value is one less than the sequence number of the differential value; and
a fourth pixel value from the second set, wherein the sequence number of the fourth pixel value is one more than the sequence number of the differential value.

3. The method of claim 2, wherein performing the calculation comprises:
subtracting the difference between the third pixel value and the fourth pixel value from the difference between the first pixel value and the second pixel value to produce a difference indication;
obtaining the absolute value of the difference indication.

4. The method of claim 1, wherein converting the captured thermal image to a first sequenced set of pixel values includes converting the captured thermal image to a set of values indicative of heat intensity of a material region corresponding to the pixel.

5. The method of claim 1, wherein converting the captured thermal image to a first sequenced set of pixel values includes associating each pixel value with a coordinate tuple including a first coordinate and a second coordinate.

6. The method of claim 5, wherein the coordinate tuple is associated with a Cartesian coordinate system, wherein the coordinate system includes two dimensions such that a first coordinate corresponds to a row and a second coordinate corresponds to a column, wherein the combination of the row and the column is indicative of the physical location on a material corresponding to the captured thermal image.

7. The method of claim 6, wherein analyzing the sequenced set of differential values comprises:
performing a row analysis of each of a selected group of rows to generate a first list of candidate regions;
performing a column analysis of each of a selected group of columns to generate a second list of candidate regions;
identifying a problem region, wherein the problem region is a region contained in both the first candidate region list and the second candidate region list.

8. The method of claim 7, wherein performing the row analysis of an individual row includes:
selecting a pixel associated with the individual row;
calculating the difference in pixel values associated with pixels surrounding the selected pixel;
comparing the calculated difference values to a reference difference in pixel values, wherein the reference difference in pixel values is calculated from the second sequenced set of pixel values.

9. The method of claim 1, wherein analyzing the sequenced set of differential values comprises:
obtaining a threshold value indicative of the maximum acceptable deviation between pixel values;
comparing the threshold value to at least one of the differential values;
identifying at least one candidate differential value, wherein the differential value is greater than the threshold value; and
identifying the region containing the sequence number equal to the sequence number of the candidate differential value in the sequenced set of differential values.

10. The method of claim 1, wherein generating each differential value in the sequenced set comprises:
selecting a candidate pixel;
obtaining an averaging factor indicative of the number of neighboring pixels to be used in the calculation of each differential value;
calculating the first average pixel value associated with the neighbors preceding the candidate pixel according to the averaging factor;
calculating the second average pixel value associated with the neighbors following the candidate pixel according to the averaging factor;
calculating the filtered differential value using the first average pixel value, the second average pixel value, and the second set of filtered values.

11. The method of claim 1, wherein converting the captured thermal image to a first sequenced set of pixel values includes creating a blob image from the captured thermal image.

12. The method of claim 1, further including conditionally generating an alarm indicative of a defect in thermal sealing depending on the analysis of the sequenced set of differential values.

13. A method of monitoring and detecting thermal sealing defects, comprising:
capturing a thermal image of a thermal seal;
obtaining a reference thermal image corresponding to an acceptable thermal seal;
associating a diagnostic region with a predetermined number of pixels;
converting the captured thermal image to a first set of pixels, wherein the first set is divided into a plurality of diagnostic regions;
converting the reference thermal image to a second set of pixels, wherein the second set is divided into a plurality of diagnostic regions;
selecting a first candidate pixel from the first set of pixels;
calculating a first difference between a first aggregate thermal value associated with a first group of neighbors on a first side of the first candidate pixel and a second aggregate thermal value associated with a second group of pixels on a second side of the first candidate pixel to produce a first operand;
selecting a second candidate pixel from the second set of pixels;
calculating a second difference between a third aggregate thermal value associated with a first group of neighbors on a first side of the second candidate pixel and a fourth aggregate thermal value associated with a second group of pixels on a second side of the second candidate pixel to produce a second operand, wherein each aggregate thermal value is indicative of thermal intensity of a corresponding physical region;
calculating the absolute value of the difference between the first operand and the second operand to produce a difference indicator;
comparing the difference indicator to a predefined threshold to produce an alarm indicator; and
generating an alarm if the alarm indicator corresponds to a predefined trigger value indicative of a thermal sealing defect.

14. The method of claim 13, wherein calculating the difference in the thermal value includes defining a row of pixels and wherein the first and the second groups of neighbors of a candidate pixel include an equal number of pixels disposed in the same row as the candidate pixel.

15. The method of claim 13, wherein calculating the difference in the thermal value includes defining a two dimensional region surrounding a candidate pixel.

16. The method of claim 13, further including reselecting the first candidate pixel and the second pixel so that a new difference indicator is produced, wherein the new difference indicator corresponds to a new physical location on the thermal seal and on the acceptable thermal seal.

17. The method of claim 16, wherein the reselecting is iteratively performed for each column of a selected row of a two dimensional region associated with the thermal seal and the acceptable thermal seal.

18. The method of claim 16, wherein the reselecting is iteratively performed for each column and row index combination corresponding to a two dimensional region associated with the thermal seal and the acceptable thermal seal.
